(19) United States
(12) Patent Application Publication
(10) Pub. No.: US 2012/0226533 A1
(43) Pub. Date: Sep. 6, 2012

(54) METHOD, SYSTEM AND COMPUTER PROGRAM PRODUCT FOR REMUNERATING ENDORSERS OF A PRODUCT AND DEMOCRATIZING PRODUCT SALES

(76) Inventor: Kelly Clark, Draper, UT (US)

(21) Appl. No.: 13/039,317

(22) Filed: Mar. 3, 2011

(51) Int. Cl. G06Q 40/00; G06Q 30/00

(52) U.S. Cl. 705/14.15; 705/14.16

(57) ABSTRACT

A method and system are disclosed for remunerating endorsers of a digital artistic product online, and of tangible products sent to purchasers, such as a video, image, or music production. An endorser of a product is compensated for recommending the product which the endorser has purchased to other users. A portion of the revenue generated either on the digital music product, or the on other products, resulting from the recommendation of the endorsers is paid to the endorser.

### BACKGROUND OF THE INVENTION

1. Field of the Invention

This invention relates to methods of marketing media products, and more specifically to a method, system and computer program product for remunerating endorsers of artistic media products.

2. Description of the Related Art

Digital copies of artistic works are sold across the Internet and retail world, including music, video, novels, and the like. Well established artists, who have favorably impressed larger labels and distributors, benefit from the notoriety and marketing efforts of those distributors which license the copyrights to the artists' productions.

The copyrights of popular artistic productions are a form of intellectual property which can reach very high valuations. For example, the value of Michael Jackson's and the Beatles' copyrights exceed $100 million, while the copyrights to the Harry Potter literary works, as well as the Star Wars® move franchise, have reached even greater values.

Identifying emerging artists with mass market appeal is a difficult task for publishing houses, record labels, film studios and other commercial enterprises. While literary, sports, and film agents who specialize in gauging the marketability of emerging artists' productions have some successes, due to the subjective nature of their evaluations, most of their conclusions are ultimately flawed.

There exists no means in the art of allowing, or forcing the market, to evaluate and determine the commercial viability of new artistic works which have yet to be marketed independently of the larger studios, publishing houses and record labels. The search costs of identifying real talent from the large pool of unpublished artists is currently prohibitively high, and there exists no means of marshaling consumers as a whole to evaluate each unpublished work

In the last decade, a number of software-based virtual record stores have emerged, such as iTunes, finding popular appeal. While these enterprises have led to a massive increase in the amount of home-produced electronic music available to the general public via the internet, even these virtual record stores exist mainly to market popular music works, rather than identify as yet unpublished works with mass market potential.

### SUMMARY OF THE INVENTION

From the foregoing discussion, it should be apparent that a need exists for a method, system and computer program product for remunerating endorsers of a digital media product and democratizing digital media sales. The present invention has been developed in response to the present state of the art; and, in particular, in response to the problems and needs in the art that have not yet been fully solved by currently available methods, systems and apparatus, and that overcome many or all of the above-discussed shortcomings in the art. Accordingly, the present invention has been developed to provide a method for remunerating endorsers of a digital media product.

A method is disclosed for remunerating endorsers of a digital media product, the steps of the method comprising: creating a virtual account for an endorser by collecting and storing one or more of an endorser's name, bank account number, bank routing number, credit card number, PayPal® account details, address, telephone number and mobile phone number in persistent computer readable storage; storing an artist's name and a digital media file comprising a reproduction of one or more of the artist's artist work(s) in persistent computer readable storage, wherein the digital media file is stored in connection with a plurality of other digital media files; exclusively associating a unique identifier with the digital media file in persistent computer readable storage; and allowing endorsers to browse summaries of the digital media files on a website accessible via an Internet.

The method further comprises uploading a digital copy of a digital media file to a terminal under the control of the endorser in response to a credit card purchase by the endorser, the digital media file selected by the endorser from a list of digital media files displayed on a website; prompting the endorser via the website to rate an entertainment value of the selected digital media file (a “rating”) after the uploading of the digital media file; accepting the rating of the entertainment value of the selected digital media file from the endorser via the website; storing the rating in computer readable memory in exclusive association with the selected digital media and with the endorser, wherein the rating is stored in connection with a plurality of earlier stored ratings; determining a collective rating for each digital media file in the computer readable storage, wherein the collective rating is determined using a Gaussian mathematical function; providing access to collective ratings via the website to browsers of the digital media files; prompting the browsers of the digital media files to purchase a digital media file with a higher collective rating than other digital media files; selling the digital media files to one or more of the browsers; and distributing a portion of the revenue generated on the digital media file to one or more of the endorsers of the digital media file.

In some embodiments, the method further comprises prompting the browsers of the digital media files to purchase a digital media file whose positive collective rating is increasing faster than positive collective rating of other digital media files in the computer readable storage.

In other embodiments, the method further comprises forcing the endorser to download and rate a secondary digital media files associated with less than a predetermined number of ratings before the endorser can download the selected digital media file.

In still further embodiments, the method further comprises prompting the browsers of the digital media files to purchase one of the digital media files associated with a higher collective rating than other digital media files. The method may further comprise distributing a percentage of income generated on future sales of the digital media file pro rata to each endorser providing a rating.

The media file may consist of an audio file, a video file, and a text file. The digital reproduction consists of a document formatted in one of WAV format, MP3 format, PDF format, MPG format, and JPG format.

The method may comprise prompting the endorser to rate one or more of the artist quality of the digital reproduction, and the emotive quality of the digital reproduction, or of forcing the endorser to download and rate a digital media files associated with less than a predetermined number of ratings before an endorser can download the selected digital media file.

The portion of revenue distributed may be distributed non-uniformly to endorsers, wherein the portion of revenue distributed to each respective endorser is allocated in accordance with an endorser prominence rating exclusively associated with each respective endorser, wherein the endorser prominence rating is determined by one a correlation between historic ratings of the endorser and subsequently determined collective ratings, and a value independently assigned to the endorser by a third-party management authority, the value representative of the endorser's prominence in pop culture.

The method may further comprise classifying each collective rating as positive, neutral or negative.

The method may further comprise: measuring revenue generated on the sale of a digital media file before receiving a negative rating from the endorser; measuring gross revenue generated on the sale of all digital media files offered on the website before receiving the negative rating the endorser; measuring a drop in revenue generated on the sale of the digital media file after receiving the negative rating from the endorser; measuring an increase in gross revenue generated on the sale of all digital media files offered on the website after receiving the negative rating the endorser; and distributing a portion of the revenue generated on the digital media file to one or more of the endorsers of the digital media file.

A computer program product comprising a computer readable medium having computer usable program code executable to perform operations for remunerating endorsers of a digital media product is also disclosed. The operations of the computer program product comprise: creating a virtual account for an endorser by collecting and storing one or more of an endorser's name, bank account number, bank routing number, credit card number, PayPal® account details, address, telephone number and mobile phone number in persistent computer readable storage; storing an artist's name and a digital media file comprising a reproduction of one or more of the artist's artist work(s) in persistent computer readable storage, wherein the digital media file is stored in connection with a plurality of other digital media files; exclusively associating a unique identifier with the digital media file in persistent computer readable storage; AND allowing endorsers to browse summaries of the digital media files on a website accessible via an Internet; further comprising forcing the endorser to download and rate a secondary digital media files associated with less than a predetermined number of ratings before the endorser can download the selected digital media file.

The operations of the computer program product further comprises uploading a digital copy of a digital media file to a terminal under the control of the endorser in response to a credit card purchase by the endorser, the digital media file selected by the endorser from a list of digital media files displayed on a website; prompting the endorser via the website to rate an entertainment value of the selected digital media file (a “rating”) after the uploading of the digital media file; accepting the rating of the entertainment value of the selected digital media file from the endorser via the website; storing the rating in computer readable memory in exclusive association with the selected digital media and with the endorser, wherein the rating is stored in connection with a plurality of earlier stored ratings; and determining a collective rating for each digital media file in the computer readable storage, wherein the collective rating is determined using a Gaussian mathematical function; providing access to collective ratings via the website to browsers of the digital media files.

The operations of the computer program product further comprise prompting the browsers of the digital media files to purchase a digital media file with a higher collective rating than other digital media files; selling the digital media files to one or more of the browsers; and distributing a percentage of the loss in revenue on the sale the digital media file to the endorser in response to an increase in gross revenue of the website and in response to a drop in revenue generated from the sale of the digital media file, wherein the portion of revenue distributed is distributed non-uniformly to endorsers, wherein the portion of revenue distributed to each respective endorser is allocated in accordance with an endorser prominence rating exclusively associated with each respective endorser, wherein the endorser prominence rating is determined by one a correlation between historic ratings of the endorser and subsequently determined collective ratings, and a value independently assigned to the endorser by a third-party management authority, the value representative of the endorser's prominence in pop culture.

A system is also disclosed for remunerating endorsers of a digital media product, the system comprising: a persistent computer readable storage; a creator module configured to create a virtual account for an endorser by collecting and storing one or more of an endorser's name, bank account number, bank routing number, credit card number, PayPal® account details, address, telephone number and mobile phone number in persistent computer readable storage; and a storage module configured to store an artist's name and a digital media file comprising a reproduction of one or more of the artist's artist work(s) in persistent computer readable storage, wherein the digital media file is stored in connection with a plurality of other digital media files.

The system further comprises an association module configured to exclusively associate a unique identifier with the digital media file in persistent computer readable storage; an allower module configured to allow endorsers to browse summaries of the digital media files on a website accessible via an Internet; an uploader module configured to upload a digital copy of a digital media file to a terminal under the control of the endorser in response to a credit card purchase by the endorser, the digital media file selected by the endorser from a list of digital media files displayed on a website; a prompter module configured to prompt the endorser via the website to rate an entertainment value of the selected digital media file (a “rating”) after the uploading of the digital media file; an acceptor module configured to accept the rating of the entertainment value of the selected digital media file from the endorser via the website; a storer module configured to store the rating in computer readable memory in exclusive association with the selected digital media and with the endorser, wherein the rating is stored in connection with a plurality of earlier stored ratings; a determiner module configured to determine a collective rating for each digital media file in the computer readable storage, wherein the collective rating is determined using a Gaussian mathematical function; and a provider module configured to provide access to collective ratings via the website to browsers of the digital media files.

The system further comprises a browser module configured to prompt the browsers of the digital media files to purchase a digital media file with a higher collective rating than other digital media files; a seller module configured to sell the digital media files to one or more of the browsers; and a distributor module configured to distribute a portion of the revenue generated on the digital media file to one or more of the endorsers of the digital media file.

The portion of revenue distributed may be distributed non-uniformly to endorsers, wherein the portion of revenue distributed to each respective endorser is allocated in accordance with an endorser prominence rating exclusively associated with each respective endorser, wherein the endorser prominence rating is determined by one a correlation between historic ratings of the endorser and subsequently determined collective ratings, and a value independently assigned to the endorser by a third-party management authority, the value representative of the endorser's prominence in pop culture.

The system may further comprise a classifier module configured to classify each collective rating as positive, neutral or negative. The system may further comprise: a net revenue measurer module configured to measure revenue generated on the sale of a digital media file before receiving a negative rating from the endorser; a gross revenue measurer module configured to measure gross revenue generated on the sale of all digital media files offered on the website before receiving the negative rating the endorser; a loss revenue measurer module configured to measure a drop in revenue generated on the sale of the digital media file after receiving the negative rating from the endorser; a increased revenue measurer module configured to measure an increase in gross revenue generated on the sale of all digital media files offered on the website after receiving the negative rating the endorser; and wherein the distributor module is further configured to distribute a portion of the revenue generated on the digital media file to one or more of the endorsers of the digital media file.

The functions of the system may be realized in method form, or by a computer program product. In some embodiments of the method, a media file is substituted for the digital media file, and the media file is sent to the endorser via one of US Postal Service, Federal Express, UPS, or DHL rather than being uploaded to the endorser's terminal or computer.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a simplified diagrammatic illustration of the flow and aggregation of money between entities participating in a system for remunerating endorsers of a digital music product in accordance with the present invention;

FIG. 2 is a process flow chart of a method of remunerating endorsers of a digital media product in accordance with the present invention;

FIG. 3 is a block diagram illustrating one system for remunerating endorsers of a digital media product in accordance with the present invention;

FIG. 4 is a process flow chart of a method of remunerating endorsers of a digital media product in accordance with the present invention; and

FIG. 5 is an entity-relationship diagram illustrating the relationship between entities working in concert to facilitate the remuneration and democratization of media marketing in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention. The apparatus modules recited in the claims may be configured to impart the recited functionality to the apparatus.

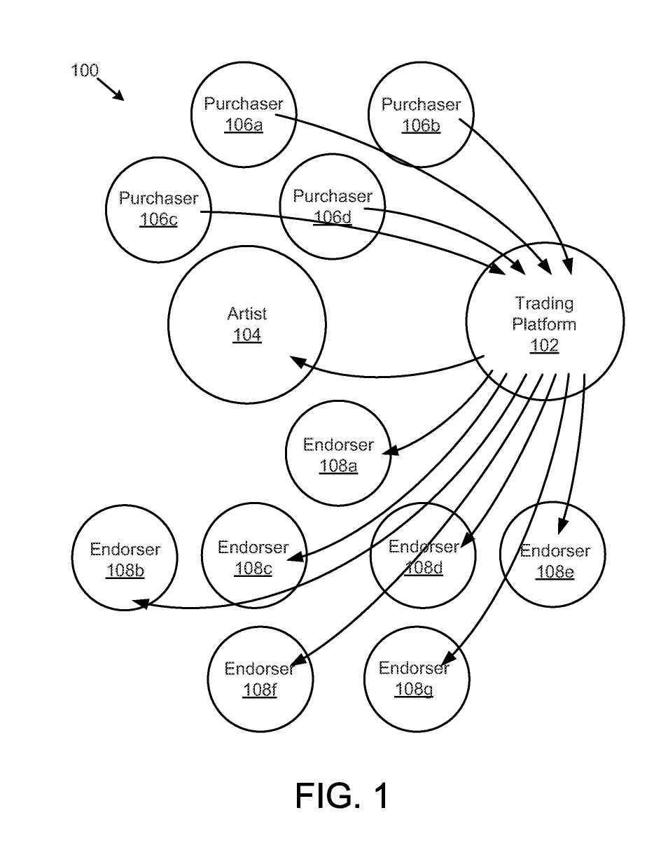

FIG. 1 is a simplified diagrammatic illustration of the flow and aggregation of money between entities participating in a system 100 for remunerating endorsers of a digital music product in accordance with the present invention. The system 100 comprises a trading platform 102, an artist 104, a purchaser 106a, a purchaser 106b, a purchaser 106c, a purchaser 106d, an endorser 108a, an endorser 108b, an endorser 108c, an endorser 108d, an endorser 108e, an endorser 108f, and an endorser 108g.

The trading platform 102, in some embodiments, comprises a computer program in firmware or persistent computer readable storage running on one or more data processing devices (DPDs), such as a server, computer workstation, router, mainframe computer, smart phone, or the like. In various embodiments, the DPD comprises one or more processors. The processor is a computing device well-known to those in the art and may include an application-specific integrated circuit (“ASIC”).

The trading platform 102 interfaces with endorsers 108a-g and purchasers 106a-d vis-à-vis an interactive website on the Internet. The trading platform 102 is configured to automatically process payments for its endorsers 108a-g, purchasers 106a-d, and other users, using means well-known to those of skill in the art, including PayPal®, credit card credits, direct bank deposits, and the like. In addition to interfacing via the website, the trading platform 102 may interact electronically with the member 104a using variations of the Simple Mail Transfer Protocol (SMTP), Internet Message Access Protocol (IMAP), Post Office Protocol (POP), or other protocols well-known to those of skill in the art.

The endorsers 108a-g may comprise any person, company or organization that is potentially a purchaser of a digital media product. The endorsers 108a-g may purchase one or more digital media products and become “incorporated” into the trading platform. Alternatively, the endorsers 108a-g may simply browse summaries of the digital media products, and view rating information, without purchasing. For the purposes of this patent, the terms “incorporate” and “incorporation” denote the act of formally enrolling an endorser 108 with the trading platform 102 by giving the trading platform 102 personal banking and personal contact information such that the endorser 108 qualifies to make purchases of digital media products and qualified to receive a portion of the change in revenue resulting from the change in revenue realized on a digital media product after the endorser 108 purchases said media product.

In the shown embodiments, during the incorporation process, an endorser 108 is prompted to provide personal contact information and/or personal banking information and/or one or more artistic digital products.

The contact information, in this embodiment, comprises personal information about the endorser 108. The contact information may include one or more of: age, address, gender, credit rating, bank account routing number, bank account number, email, telephone number, fields of artistic interests, income, and the like. In typical embodiments, the contact information is stored in computer readable memory, or emailed to the trading platform 102 using programs well-known to those of skill in the art, such Microsoft Outlook, Thunderbird, Yahoo! Mail, and the like.

An artist is incorporated into the trading platform 102 in the same manner that an endorser is incorporated into the online trading platform. The difference between an artist and endorser 108 is that the artist uses the trading platform 102 primarily for uploading digital media products the artist and/or its sponsor hopes to profit from. The purchasers 106a-d likewise comprise individuals and/or organizations incorporated into the trading platform 102 who have purchased a digital media product, but not yet endorsed it positively or negatively.

The digital media product is uploaded by an artist or an endorser 108. In some embodiments, the digital media product is mailed to the endorser on a physical medium, such as CD, DVD, cassette or the like. The digital media product may comprise any digital media or multimedia product capable of being stored in computer readable persistent memory, including music, video, audio, images, and text, including formats from the group comprising MPG, MP3, MP4, WAV, PDF, WORD, DOC, WPD, Flash®, and the like. Examples of digital media products include music compositions (including rock, country, opera, religious, classical), video (documentaries, fictional, etc), text (novels, biographies, autobiographies, scripts, plays, text books, picture books, children's books, etc), and images (clipart, journalistic, familiar, etc), or any combination of the above.

The arrows in FIG. 1 show the flow of money from the purchasers 106a-d to the trading platform 102 to endorsers 108a-g. This money flows, to the positive endorsers of a digital media product. In various embodiments, to the negative endorsers of the digital media product or media product may also be compensated.

As shown, purchasers 106a-d send funds to the trading platform 102 when digital media products are purchased and downloaded, or when media products are purchased and send on CD, DVD and the like to the purchasers via US Postal Service, Federal Express, DHL, UPS, and the like.

In some embodiments of the present invention, a tangible product may be substituted in place of a digital media product. Thus, in some embodiments, a vacuum cleaner might be sent to an endorser for a rating instead of a DVD and the like. In some embodiments of the present invention, endorsers whose endorsements have proven economically more viable, or more predicative of future sales, might receive random products for their endorsement, from couches to CDs, to DVDs, with permanent ownership of such products conveyed to the endorser upon the endorser providing a rating of said product.

In some embodiments, a DPD may be configured with software or firmware to track the shipping status of tangible products to endorser(s) using tracking numbers, including by passing such tracking numbers as parameters to websites or APIs maintained by UPS, the US Postal Service, Federal Express, and the like.

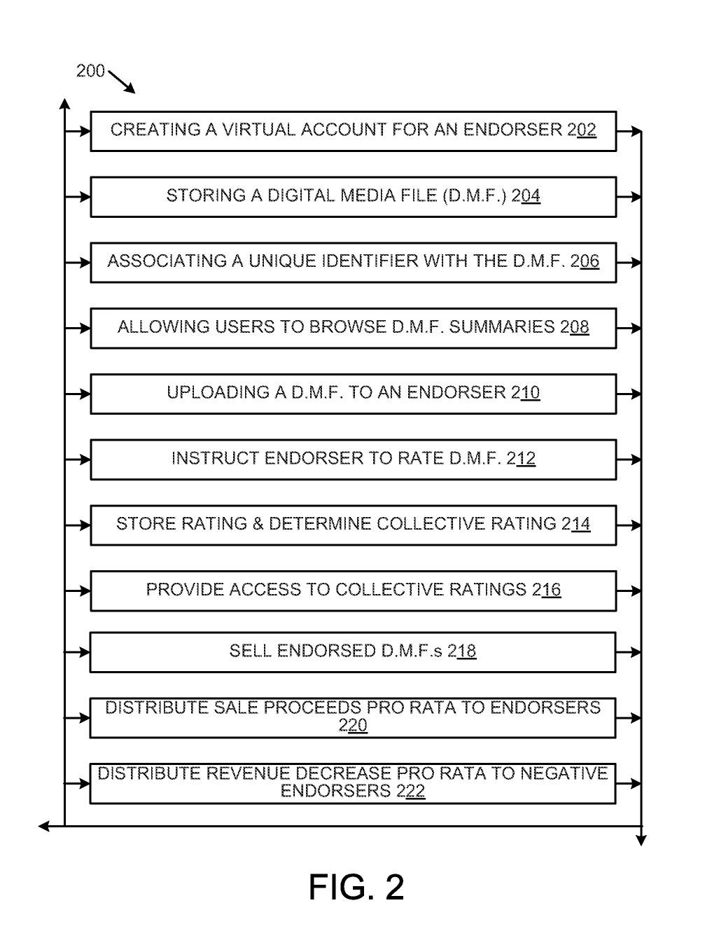

FIG. 2 is a process flow chart of a method 200 of remunerating endorsers of a digital media product in accordance with the present invention.

The method 200 begins 202 when a virtual account is created via a website for the endorser 108 a digital media product. The account may comprise personal identifying information of the endorser 108, or an organization with which the endorser 108 is affiliated, such as a band or corporate entity.

The method 200 progresses when a digital media file is stored 204 in computer readable storage accessible by the functions of the website creating the virtual account.

Next, a unique identifier is exclusively associated 206 with the digital media file in persistent computer readable storage, followed by allowing 208 endorsers to browse summaries of the digital media files on a website accessible via an Internet. There may be a plurality of unique identifiers associated with unique digital content in the form of computer readable files. The unique identifiers may be mapped as keys in a hash table.

Subsequently, a digital copy of a digital media file is uploaded 210 to a terminal under the control of the endorser in response to a credit card purchase by the endorser. The digital media file may be selected by the endorser from a list of digital media files displayed on a website.

Next, the endorser may be prompted, or instructed 212, to rate an entertainment value of the selected digital media file (a “rating”) after the uploading of the digital media file.

The method 200 may include an accepting step in which the rating of the entertainment value of the selected digital media file is accepted from the endorser via the website.

The method includes a step 214 in which the rating is stored 214 in computer readable memory in exclusive association with the selected digital media and with the endorser, wherein the rating is stored in connection with a plurality of earlier stored ratings.

The collective rating is then determined for each digital media file in the computer readable storage, wherein the collective rating is determined using a Gaussian mathematical function.

The method 200 then provides 216 access to collective ratings via the website to browsers of the digital media files, and may subsequently prompt the browsers of the digital media files to purchase a digital media file with a higher collective rating than other digital media files.

Next, the method 200 includes selling 218 the digital media files to one or more of the browsers, followed by distributing 200 a portion of the revenue generated on the digital media file to one or more of the endorsers of the digital media file.

In some embodiment, the method 200 may also comprise a step of distributing 222 revenue decrease pro rata to negative endorsers of the digital media product.

The method 200 may further comprise measuring revenue generated on the sale of a digital media file before receiving a negative rating from the endorser; and/or measuring gross revenue generated on the sale of all digital media files offered on the website before receiving the negative rating the endorser.

The method 200, in some embodiments, may further comprise measuring a drop in revenue generated on the sale of the digital media file after receiving the negative rating from the endorser; and/or measuring an increase in gross revenue generated on the sale of all digital media files offered on the website after receiving the negative rating the endorser.

In still further embodiment, the method 200 may comprise distributing a portion of the revenue generated on the digital media file to one or more of the endorsers of the digital media file.

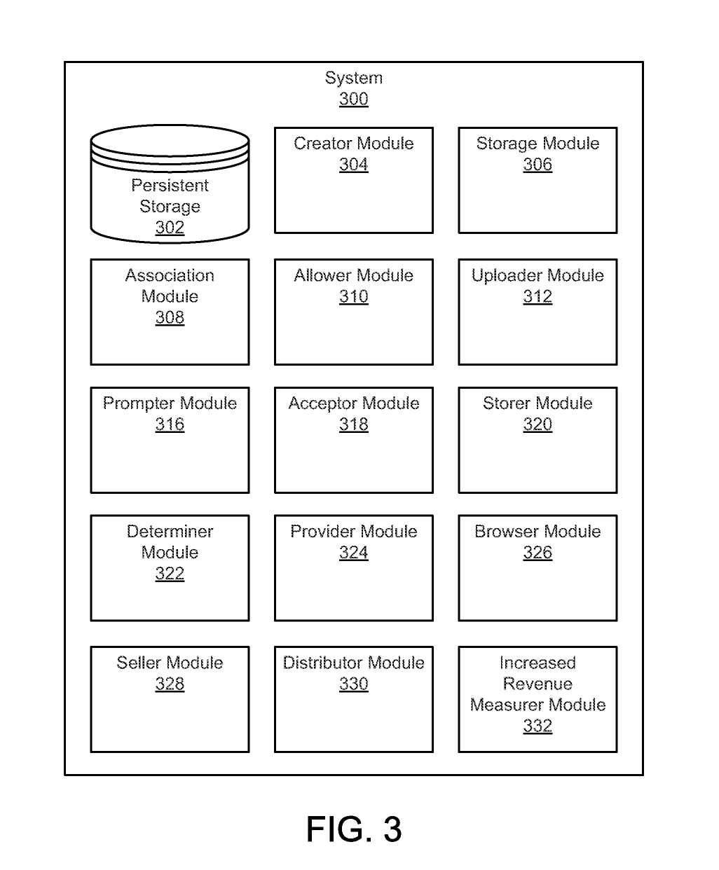

FIG. 3 is a block diagram illustrating one system 300 for remunerating endorsers of a digital media product in accordance with the present invention. The system 300 comprises a persistent storage 302, a creator module 304, a storage module 306, an association module 308, an allower module 310, uploader module 312, prompter module 314, acceptor module 318, storer module 320, determiner module 322, provider module 324, browser module 326, seller module 328, distributor module 330, and increased revenue measurer module 330.

The modules of the system 300 each are respectively configured to perform one of the steps of the method 200 above, and namesaked on the steps of the method 200 which they perform.

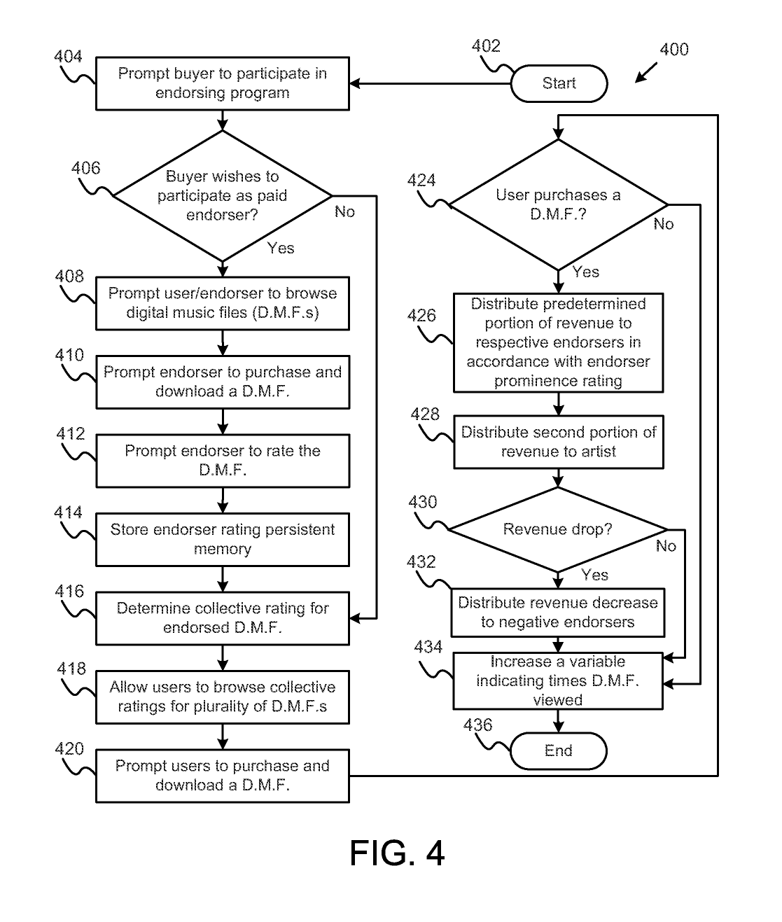

FIG. 4 is a process flow chart of a method 400 of remunerating endorsers of a digital media product in accordance with the present invention.

The steps of the method 400 proceed as shown.

The method 400 includes a step of distributing 426 a predetermined portion of revenue to the endorsers of a digital media product in accordance with an endorser prominence rating.

While the endorser prominence rating is described in some embodiments above, the endorser prominence rating may further be defined as a rating of a respective endorser 108 rather than a rating of an endorsed media product. The endorser prominence rating may increase linearly as the endorser endorsers more and more digital products online In some embodiments, the ratings may comprise a prediction of future market success the endorser 108 believes will be attained by a media product, rather than a rating comprising the degree to which the endorser 108 appreciates the media product. In embodiments in which the rating comprises a prediction of future market success, the endorser prominence rating may increase linearly or exponentially as the media products endorsed by the endorser 108 perform as the endorser predicts.

The endorser prominence rating may be used in calculating what portion, percentage, or amount of royalties generated on the sale of media product should be distributed to the endorser 108. In some embodiments, the endorser prominence rating is indicative of the number of shares of the collective royalty payments that an endorser 108 will receive. Thus, an endorser 108 with an endorser prominence rating of 6 would receive 40% less revenue of the sale of a digital media product than an endorser with a prominence rating of 10.

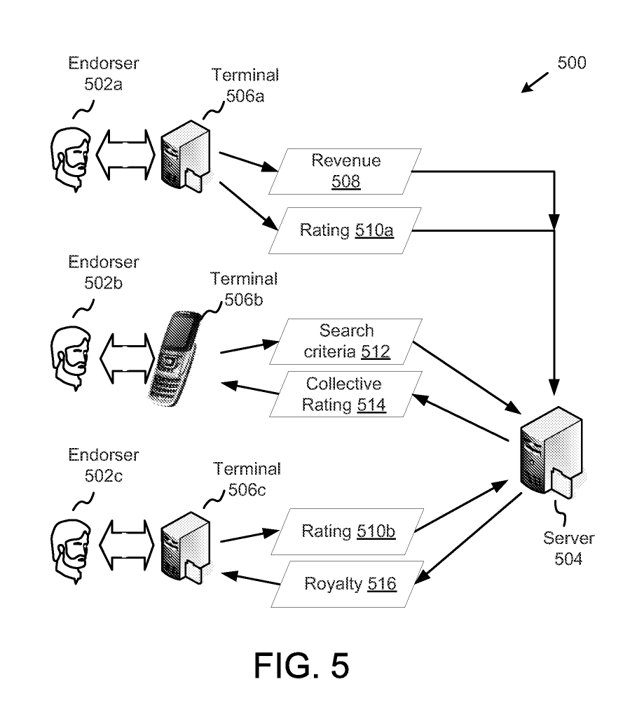

FIG. 5 is an entity-relationship diagram illustrating the relationship between entities working in concert within a system 500 to facilitate the remuneration and democratization of media marketing in accordance with the present invention. The system 500 comprises endorsers 502a-c, a server 504, terminals 506a-c, revenue 508, ratings 510a-b, search criteria 512,

In the shown embodiment, the terminals 506a-c may comprise personal computers, workstations, or smart cellular phones as shown (i.e. terminal 506b). In the shown embodiments, the endorsers 502a-c comprise individuals exclusively controlling the terminals 506a-c.

Endorsers 502a, via terminal 506a, sends revenue 508 to the server 504, which server 504 hosts a website interacting with the endorser 502a. The revenue 508 may be sent via any means well-known to those of skill in the art, including credit card, PayPal, eCheck, and the like.

Subsequently, the endorser 502a submits a rating 510a of a digital media product that the endorser received in the mail. This rating 510a is stored by the server 504 in computer readable storage and used to calculate a collective rating made available to other endorsers 502a-c.

The endorser 502b, in the shown embodiment, is attempting to identifier an enjoyable digital media product by submitting search queries, or search criteria 512, to the server 504. The server 504 returns to the endorser 502b a summary of digital media products that the servers maintains in computer readable store, or which the server 504 may instruct a third-party to physically mail the endorser 502b. The server 504 comprises software which runs a website. The server 504 and the software collectively form a trading platform 102.

The endorser 502c, in the shown embodiment, submits a rating 510b on a digital media product the endorser 502c has purchased to the server 504. Because the server concludes that the endorser 502c's rating 510b has contributed to a statistically significant increase in sales of the digital media product referenced by the rating 510b to endorsers such as endorser 502b, a portion of the increase in sales is paid to the endorser 502c in the form of the royalty 516. In other embodiments, a portion of gross sales, rather than the sales increase, is paid to the endorser 502c.

In some embodiments of the present invention, the member 104 first contacts his personal contacts before relaying their contact information to the solicitor 108. In various embodiments of the present invention, the member 104 may send a sample product and personalized message to one or more of his personal contacts before those contacts are solicited by the solicitor 108.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for remunerating endorsers of a digital media product, the steps of the method comprising:
creating a virtual account for an endorser by collecting and storing one or more of an endorser's name, bank account number, bank routing number, credit card number, PayPal® account details, address, telephone number and mobile phone number in persistent computer readable storage;
storing an artist's name and a digital media file comprising a reproduction of one or more of the artist's artist work(s) in persistent computer readable storage, wherein the digital media file is stored in connection with a plurality of other digital media files;
exclusively associating a unique identifier with the digital media file in persistent computer readable storage;
allowing endorsers to browse summaries of the digital media files on a website accessible via an Internet;
uploading a digital copy of a digital media file to a terminal under the control of the endorser in response to a credit card purchase by the endorser, the digital media file selected by the endorser from a list of digital media files displayed on a website;
prompting the endorser via the website to rate an entertainment value of the selected digital media file (a “rating”) after the uploading of the digital media file;
accepting the rating of the entertainment value of the selected digital media file from the endorser via the website;
storing the rating in computer readable memory in exclusive association with the selected digital media and with the endorser, wherein the rating is stored in connection with a plurality of earlier stored ratings;
determining a collective rating for each digital media file in the computer readable storage, wherein the collective rating is determined using a Gaussian mathematical function;
providing access to collective ratings via the website to browsers of the digital media files;
prompting the browsers of the digital media files to purchase a digital media file with a higher collective rating than other digital media files;
selling the digital media files to one or more of the browsers; and
distributing a portion of the revenue generated on the digital media file to one or more of the endorsers of the digital media file.

2. The method of claim 1, further comprising prompting the browsers of the digital media files to purchase a digital media file whose positive collective rating is increasing faster than positive collective rating of other digital media files in the computer readable storage.

3. The method of claim 1, further comprising forcing the endorser to download and rate a secondary digital media files associated with less than a predetermined number of ratings before the endorser can download the selected digital media file.

4. The method of claim 1, further comprising prompting the browsers of the digital media files to purchase one of the digital media files associated with a higher collective rating than other digital media files.

5. The method of claim 1, further comprising distributing a percentage of income generated on future sales of the digital media file pro rata to each endorser providing a rating.

6. The method of claim 1, wherein the media file consists of an audio file, a video file, and a text file.

7. The method of claim 1, wherein the digital reproduction consists of a document formatted in one of WAV format, MP3 format, PDF format, MPG format, and JPG format.

8. The method of claim 1, further comprising prompting the endorser to rate one or more of the artist quality of the digital reproduction, and the emotive quality of the digital reproduction.

9. The method of claim 1, further comprising forcing the endorser to download and rate a digital media files associated with less than a predetermined number of ratings before an endorser can download the selected digital media file.

10. The method of claim 1, wherein the portion of revenue distributed is distributed non-uniformly to endorsers, wherein the portion of revenue distributed to each respective endorser is allocated in accordance with an endorser prominence rating exclusively associated with each respective endorser, wherein the endorser prominence rating is determined by one a correlation between historic ratings of the endorser and subsequently determined collective ratings, and a value independently assigned to the endorser by a third-party management authority, the value representative of the endorser's prominence in pop culture.

11. The method of claim 1, further comprising classifying each collective rating as positive, neutral or negative.

12. The method of claim 1, further comprising:
measuring revenue generated on the sale of a digital media file before receiving a negative rating from the endorser;
measuring gross revenue generated on the sale of all digital media files offered on the website before receiving the negative rating the endorser;
measuring a drop in revenue generated on the sale of the digital media file after receiving the negative rating from the endorser;
measuring an increase in gross revenue generated on the sale of all digital media files offered on the website after receiving the negative rating the endorser; and
distributing a portion of the revenue generated on the digital media file to one or more of the endorsers of the digital media file.

13. A method for remunerating endorsers of a media product, the steps of the method comprising:
creating a virtual account for an endorser by collecting and storing one or more of an endorser's name, bank account number, bank routing number, credit card number, PayPal® account details, address, telephone number and mobile phone number in persistent computer readable storage;
storing an artist's name in persistent computer readable storage;
exclusively associating a unique identifier in persistent computer readable storage with an artistic work of the endorser;
allowing the endorser to browse summaries of media files on a website accessible via an Internet;
sending the media file on a tangible medium to the endorser via one of US postal service, Federal Express, UPS, and DHL;
prompting the endorser via the website to rate an entertainment value of the media file (a “rating”) after the uploading of the media file;
accepting the rating of the entertainment value of the selected media file from the endorser via the website;
storing the rating in computer readable memory in exclusive association with the selected media and with the endorser, wherein the rating is stored in connection with a plurality of earlier stored ratings;
determining a collective rating for each media file in the computer readable storage, wherein the collective rating is determined using a Gaussian mathematical function;
providing access to collective ratings via the website to browsers of the media files;
prompting the browsers of the media files to purchase a digital media file with a higher collective rating than other media files;
selling the media files to one or more of the browsers; and
distributing a portion of the revenue generated on the media file to one or more of the endorsers of the media file.

14. A computer program product comprising a computer readable medium having computer usable program code executable to perform operations for remunerating endorsers of a digital media product, the operations of the computer program product comprising:
creating a virtual account for an endorser by collecting and storing one or more of an endorser's name, bank account number, bank routing number, credit card number, PayPal® account details, address, telephone number and mobile phone number in persistent computer readable storage;
storing an artist's name and a digital media file comprising a reproduction of one or more of the artist's artist work(s) in persistent computer readable storage, wherein the digital media file is stored in connection with a plurality of other digital media files;
exclusively associating a unique identifier with the digital media file in persistent computer readable storage;
allowing endorsers to browse summaries of the digital media files on a website accessible via an Internet;
further comprising forcing the endorser to download and rate a secondary digital media files associated with less than a predetermined number of ratings before the endorser can download the selected digital media file;
uploading a digital copy of a digital media file to a terminal under the control of the endorser in response to a credit card purchase by the endorser, the digital media file selected by the endorser from a list of digital media files displayed on a website;
prompting the endorser via the website to rate an entertainment value of the selected digital media file (a “rating”) after the uploading of the digital media file;
accepting the rating of the entertainment value of the selected digital media file from the endorser via the website;
storing the rating in computer readable memory in exclusive association with the selected digital media and with the endorser, wherein the rating is stored in connection with a plurality of earlier stored ratings;
determining a collective rating for each digital media file in the computer readable storage, wherein the collective rating is determined using a Gaussian mathematical function;
providing access to collective ratings via the website to browsers of the digital media files;
prompting the browsers of the digital media files to purchase a digital media file with a higher collective rating than other digital media files;
selling the digital media files to one or more of the browsers; and
distributing a percentage of the loss in revenue on the sale the digital media file to the endorser in response to an increase in gross revenue of the website and in response to a drop in revenue generated from the sale of the digital media file, wherein the portion of revenue distributed is distributed non-uniformly to endorsers, wherein the portion of revenue distributed to each respective endorser is allocated in accordance with an endorser prominence rating exclusively associated with each respective endorser, wherein the endorser prominence rating is determined by one a correlation between historic ratings of the endorser and subsequently determined collective ratings, and a value independently assigned to the endorser by a third-party management authority, the value representative of the endorser's prominence in pop culture.

15. A system for remunerating endorsers of a product, the system comprising:
a persistent computer readable storage;
a creator module configured to create a virtual account for an endorser by collecting and storing one or more of an endorser's name, bank account number, bank routing number, credit card number, PayPal® account details, address, telephone number and mobile phone number in persistent computer readable storage;
a storage module configured to store an artist's name;
an association module configured to exclusively associate a unique identifier with a product;
an allower module configured to allow endorsers to browse summaries of the products on a website accessible via an Internet;
an purchaser module configured to allow an endorser to purchase a product selected by the endorser from a list of digital media files displayed on a website;
a prompter module configured to prompt the endorser via the website to rate an enjoyment value of the selected product (a “rating”) after electronic verification that the endorser has received the product;
an acceptor module configured to accept the rating of the enjoyment value of the selected product from the endorser via the website;
a storer module configured to store the rating in computer readable memory in exclusive association with the unique identifier, wherein the rating is stored in connection with a plurality of earlier stored ratings;
a determiner module configured to determine a collective rating for each of a plurality of products, wherein the collective rating is determined using a Gaussian mathematical function;
a provider module configured to provide access to collective ratings via the website to browsers of product descriptions;
a browser module configured to prompt the browsers of product summaries to purchase a product with a higher collective rating than other products;
a seller module configured to sell the product to one or more of the browsers; and
a distributor module configured to distribute a portion of the revenue generated on the product to one or more of the endorsers of the product.

16. The system of claim 15, wherein the portion of revenue distributed is distributed non-uniformly to endorsers, wherein the portion of revenue distributed to each respective endorser is allocated in accordance with an endorser prominence rating exclusively associated with each respective endorser, wherein the endorser prominence rating is determined by one a correlation between historic ratings of the endorser and subsequently determined collective ratings, and a value independently assigned to the endorser by a third-party management authority, the value representative of the endorser's prominence in pop culture.

17. The system of claim 15, further comprising a classifier module configured to classify each collective rating as positive, neutral or negative.

18. The system of claim 15, further comprising:
a net revenue measurer module configured to measure revenue generated on the sale of a product before receiving a negative rating from the endorser;
a gross revenue measurer module configured to measure gross revenue generated on the sale of all products offered on the website before receiving the negative rating the endorser;
a loss revenue measurer module configured to measure a drop in revenue generated on the sale of the product after receiving the negative rating from the endorser;
a increased revenue measurer module configured to measure an increase in gross revenue generated on the sale of all products offered on the website after receiving the negative rating the endorser; and
wherein the distributor module is further configured to distribute a portion of the revenue generated on the product to one or more of the endorsers of the digital media file.
